(19) United States
(12) Patent Application Publication
(10) Pub. No.: US 2006/0174232 A1
(43) Pub. Date: Aug. 3, 2006

(54) Interger-based calculation method

(75) Inventors: John McCalla, Montreal (CA); Luc Dion, Montreal (CA)

Correspondence Address: MUNSCH, HARDT, KOPF & HARR, P.C.;INTELLECTUAL PROPERTY DOCKET CLERK, 3800 LINCOLN PLAZA, 500N AKARD STREET, DALLAS, TX, 75201, US

(73) Assignee: Bluestreak Media Inc.

(21) Appl. No.: 11/049,477

(22) Filed: Feb. 2, 2005

(51) Int. Cl. G06F 9/45

(52) U.S. Cl. 717/139

(57) ABSTRACT

A process running on, for example, an embedded device without a floating point unit performs a calculation or series of calculations called for in a program written in an language that specifies floating point representation of all numbers using integer arithmetic, unless or until it must execute the calculation using floating point arithmetic due to presence of a non-integer number. Once this happens, the remaining calculations in the series of calculations are automatically handled using floating point arithmetic. Substantially fewer processor operations are necessary to perform the calculations using integer values than floating point values.

### FIELD OF THE INVENTION

The invention pertains generally to execution of scripting languages on processing systems that do not have specialized hardware for supporting floating point representations of numerical values, particularly embedded systems such as cable and satellite “set top boxes.”

### BACKGROUND OF THE INVENTION

Programming languages are characterized in part by whether or how strongly a language is “typed.” A “type”—short for “datatype”—is a label or name for a set of values and operations that can be carried out on the values. Examples of primitive datatypes include integer, floating point number, or a character string. Typing dictates how a program will treat a particular piece of data. When typing is enforced, it acts as a constraint on how program instructions are permitted to act on data elements. Typing can either be explicit, meaning that the datatype must be declared by the programmer, or implicit, meaning that the compiler or interpreter determines the datatype.

A “scripting” language, which is a type of programming language, favors a different style of programming than conventional programming languages. Scripting languages favor rapid development over execution efficiency, and they are often interpreted rather than compiled for execution. Supporting primarily higher level operations, management of memory and variables and creations of data structures is generally limited or not available. For example, one of the most widely used and common scripting languages, ECMAScript, which at one time was referred to as “Java Script”, does not support, or permit declaration, of a number as either an integer or a floating point. It simply has a datatype called “number.” The language was intended to be very flexible and very easy to us. In the IEEE 754 Standard, double floating point representation of numerical values was selected as the manner in which numbers would be represented for the script's “number” type, as it has a number of advantages and can represent both integers and fractional numbers. Therefore, programs that interpret and execute ECMAScript assume that the binary digits stored represent for a number encodes the number using floating point representation—double precision floating point to be exact.

A general purpose computer, such as a personal computer, typically has a central processing unit (CPU) and specialized hardware called a floating-point unit (FPU). An FPU relieves the CPU of processor-intensive operations on numbers represented using double floating point notation. Therefore, floating point numbers in programming do not present problems for modem, general purpose computers.

However, “embedded systems” or “embedded devices” typically do not have an FPU. Microprocessors or other logic circuits embedded in special purpose devices or equipment are programmed to perform specific functions for the device. Economic considerations dictate that embedded systems have limited processing capability and memory—just enough to perform their intended functions. They are not intended to be independently programmable by end users. Therefore, in most cases, relatively inexpensive microprocessors without FPUs are used.

Integer based arithmetic operations are preferred for embedded systems. An integer value also requires only half the memory space as an equivalent IEEE double-precision floating-point value. Applications that use only integer based arithmetic will therefore also have significantly smaller memory requirement, which is a significant advantage on embedded systems having limited memory.

Although originally intended for relatively simply tasks, scripting languages are increasingly popular and are being used for more complex tasks. For example, all script-enabled web browsers and most major operating systems such as in Microsoft® Windows support one of the most common and widely used scripting languages, ECMAScript. This scripting language is also used in Macromedia® Flash® encoded, multi-media files.

Calculations in programs, such as games, for generating 2-dimensional graphics can be, and are frequently written, to use only integers and integer operations to speed up execution and reduce calculation time. However, it is very difficult to avoid introducing floats into a calculation, as shown by the following example: (9*2)/5 results in a fractional number that must be represented using a floating point, despite only integers being used as the arguments for the operation. Of course, once a floating point number is used in a calculation a floating point number is frequently the result. Thus, in a series of calculations, such as that used to describe the location of objects in a game or application, this means that the introduction of a floating number at any time will “pollute” all subsequent calculations as floats. Therefore, it is not possible to assume in ECMAScript and similar programming languages that the results of all arithmetic operations will be integers. All numbers must be assumed to be floating point.

Consequently, a programming language such as ECMAScript, which does not distinguish between an “integer” and a floating point number, is almost unusable for programming on embedded systems. A floating-point operation usually runs hundreds of times slower than an equivalent integer based arithmetic operation. There is little that programmers using scripting languages can do to speed up execution. The best solution is to add an FPU, which is not desirable for economic reasons.

Therefore, despite strong interest in using embedded devices such as cable and satellite television set top boxes for displaying web content and running programs, the poor performance on embedded systems of popular scripting languages discourages and makes more difficult development of programs and multi-media content using, for example, Macromedia® Flash®.

### SUMMARY OF THE INVENTION

The invention is directed generally to overcoming one or more of problems associated with running on a processor lacking a floating point unit programs written in a language that does not permit specifying whether a number is of an integer type and that treats all numbers as being represented using floating point representation (single or double.) Such a language will be referred as “untyped” for purposes of this specification. Among other advantages the invention enables programs and multi-media files written with scripting languages to be more efficiently run on embedded systems, such as cable and satellite television set top boxes.

According to a preferred embodiment of the invention, a process running on, for example, an embedded device, performs a calculation or series of calculations called for in a program or script written in an untyped language using integer arithmetic—in other words, as if the numerical values in the calculations are integers—unless or until it must execute the calculation using floating point arithmetic. Once this occurs, the remaining calculations in the series of calculations are automatically handled using floating point arithmetic. Substantially fewer processor operations are necessary to perform the calculations using integer values than floating point values. The total number of operations necessary to perform the series of calculations is therefore substantially reduced. In a series of calculations, such as one used to describe the location of objects in a game, use of integer arithmetic until a floating point number “pollutes” the calculations saves substantial amounts of processing time, even if calculations must be finished using floating point arithmetic.

Programmers are therefore not required to be concerned about transforming numbers from integer to floating point. They need not use more complex or difficult programming languages that are more “strongly typed,” and may even employ widely available authoring or development tools that further simplify development of programs. Yet, they receive the benefits in terms of performance of using integer based calculations when possible.

The invention has additional advantages when applied to cable and satellite television set top boxes, as such embedded systems rarely include floating point units. For example, the invention permits set top boxes to run programs and playback multi-media files containing scripts or instructions written in an untyped language, while significantly reducing performance penalties.

Additional advantages and aspects of the invention are explained, or will be evident from, the following detailed description of a preferred embodiment of the invention.

### BRIEF DESCRIPTION OF THE DRAWINGS

FIG. 1 is a flow chart representing the logical behavior of a software-based process for determining whether to perform integer or floating point operations in response to instructions programmed using a language that does not have an integer datatype.

FIG. 2 is schematic representation of an embedded device or system.

FIG. 3 is a schematic representation of certain processes occurring on a central processing unit of a embedded device or system.

FIG. 4 is a schematic representation of certain processes occurring on a central processing unit of an embedded device or system.

### DETAILED DESCRIPTION

In the following description, like numerals refer to like elements.

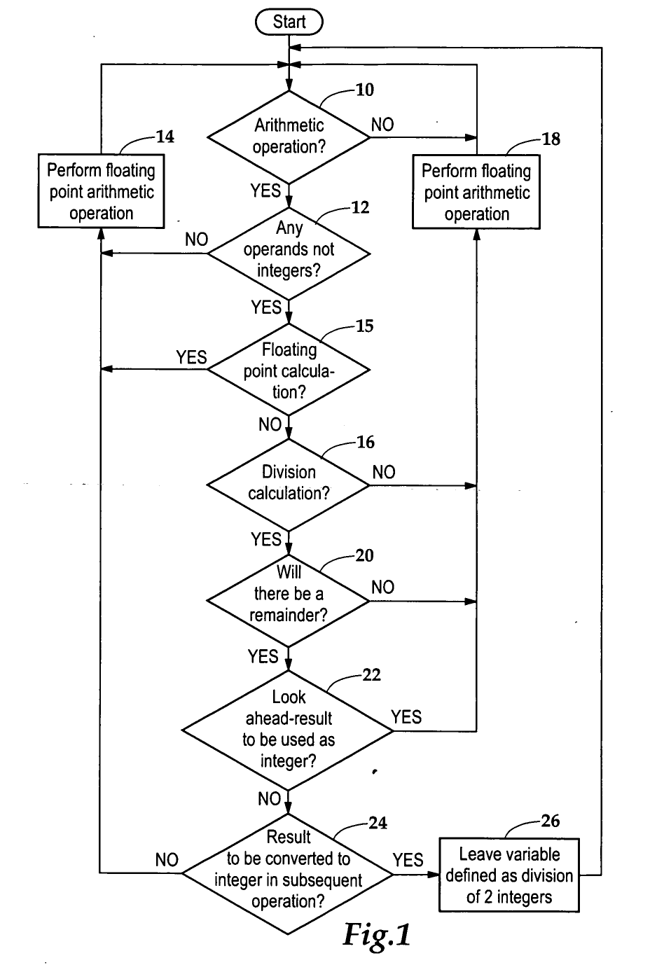

The flow diagram of FIG. 1 is a high level representation of one embodiment of a routine within a process of interpreting a programming language that does not have an integer datatype. The process permits more efficient calculations on embedded devices or systems that do not have a floating point unit (FPU) in addition to a central processing unit (CPU). Although illustrated as a single process for purposes of explanation, it may be implemented as part of a larger process, or be implemented (in whole or in part) in multiple processes.

Generally speaking, the process, in its preferred embodiment, recognizes whether the numbers involved in a calculation are all integers and then looks ahead to determine if the calculation can be carried out using integer arithmetic rather than floating point arithmetic. It preferably also avoids “contaminating” a calculation pipeline with floating point numbers. A calculation pipeline involves a series of calculations in which a result of a prior calculation is used in a subsequent calculation.

The decision loop involving step 10 represents that the process is not initiated until there is an instruction involving a calculation. When a calculation is to be performed, the process examines at step 12 whether each number—which would be represented using floating point representation—used in the arithmetic operation to determine whether or not it is an integer. If one or more are not integers, the operation is carried out using floating point arithmetic, as indicated by step 14. As indicated by decision step 15, a calculation that must be carried out using floating point representation, such as sine and cosine, is executed using floating point representation after the numbers are converted to floating point representation. If all of the numbers are integers, the process determines at step 16 whether the calculation involves division, which may be carried out either by a floating point or integer arithmetic. If it is not a division step, the calculation is carried out using integer arithmetic operations at step 18. If it does involve division, the process determines at decision step 20, whether the operation would result in a remainder. In the preferred embodiment, it carries out an integer division operation. This operation can typically be performed in a single clock cycle. If there is no remainder (i.e. the remainder is 0), integer division is performed at step 18. Step 20 is an example of a more generalized concept of a “look ahead” algorithm or test for whether or not an operation can be carried out using integer representation. The test exploits a mathematic property of the operation and can be performed very quickly as compared to the time it would take to perform the floating point operation, thus conserving processor resources. Tests for other operations could also be devised.

Otherwise, beginning at step 22, the process looks ahead to determine, if possible, how the result will be used. If it determines if the result will only be used as an integer within the program, the process will execute the calculation using integer arithmetic. For example, if a script or program is attempting to center a graphic of the display it will typically do something like this:
(WidthOfDisplay−WidthOfGraphic)/2

If the result of the subtraction is odd, the operation would return a fractional value that must be represented as a floating point. However, the process will look ahead, determine that the result is only used later on by an object that requires an integer as its input, and never go through all the conversions and floating-point operations.

Similarly, as indicated by decision step 22, the process also determines the result if the step will be used in a subsequent integer calculation. If not, the division calculation is carried out using floating point arithmetic at step 14. However, if it will be used in a subsequent integer operation, the preference is to leave the variable storing the result defined as a quotient or division of two integers, as indicated by step 26, to avoid contaminating the calculation pipeline with a floating point number. In a preferred embodiment, the process at step 26 looks for an instruction similar to the following:
var e=int (a/b);

In this specific case the division will be performed by integer arithmetic if a and b are integers, even if the result would need a floating point representation. The process can take advantage of a common scripting command, such as “int()” in the “ActionScript” scripting language of Macromdia® Flashy®, to force the process engine to automatically designate any calculation result as an integer. Other than this use of a standard ActionScript command, the integer-based calculation methods of the process of FIG. 1 can be made undetectable to the developer and to the end-user.

An example of a program or application calculations to specify and redraw the location of objects on the television screen. For instance, a game might include a ball that moves across the screen at an accelerating rate of speed; the ball appears on the screen at a precise location that is the result of its previous location, how hard the ball bounced off an obstacle, the programmed value for gravitational pull, and so on. The ball's location on the screen is defined by X and Y coordinates. If, for example, a calculation requires the ball to move across one-third of the screen's width, this new location would be represented by (width/3), which results in a float. A calculation that is accurately enough to produce a result that includes a fraction of a pixel is useless. All that is required is an estimate of the ball's new location, approximating where one-third of the screen width lies. The process of FIG. 1 recognizes that the division of one integer by another will probably produce a floating value, and recognizes that the exact precision afforded by using floats is not needed. The process therefore keeps, for example, the number represented as “width/3”, not computing the final result until it finishes all calculations that include the number.

The process of FIG. 1 is particularly useful for executing programs written in a language that does not permit typing of a number as an integer, on “embedded systems” or “embedded devices” that do not have floating point units (FPU) for offloading processor-intensive floating point operations.

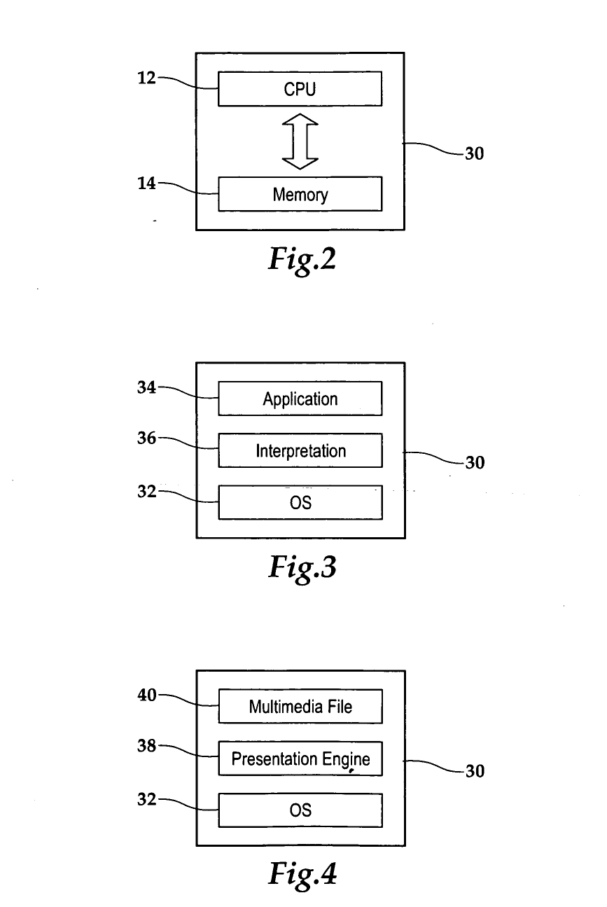

FIG. 2 schematically represents the basic components of an embedded system 30. It is comprised of a central processing unit (CPU) 32 and memory 34. As is typical, the CPU does not have, in this instance, a floating point unit (FPU) or other logic circuit (e.g. a math coprocessor) for assisting with mathematical calculations. The embedded system will also have additional elements relating to the particular purpose of the embedded system. For example, if the embedded system is a satellite or cable set top box, it would also include a tuner and interfaces for video and audio. Memory 34 is intended to represent memory generally and is not intended to represent any particular memory structure. Memory in an embedded system will depend on the purpose of the system, but it typically will include some type of memory for long term storage (typically non-volatile) and working memory for use by the processor in storing program code and data.

Such a embedded system will have one or more processes executing on. FIG. 3 represents typical processes that may be executing on embedded system 30. The processes are the result of programs executing on the CPU. The instructions of the programs are stored in memory 14. In some types of embedded systems, instructions are permanently stored in a read only memory, with the intention that additional programs cannot be added by an end user. However, other types of embedded systems are capable of running additional programs. These programs may be loaded may be loaded into memory from portable storage media or transmitted electronically to the embedded system for storage. Therefore, embedded system 30, like many systems, has certain standard processes 32 performed by operating system. Logic for the functions to be provided by the embedded system is then typically programmed into one or more application programs 34. Such an embedded system may permit and provide for a mechanism to load additional applications by a user or at the request of a user.

For example, if the embedded system 30 is a set top box for a cable television system, applications may include menu or television guide programs. Additional applications that could be loaded include games, web browsers, news tickers and other types of applications that will be used to display interactively information on a television or audio system.

Although these applications may be compiled, they may also be written using a scripting language or include script components. In order to execute scripts in which an application is written, as well as to execute scripts that may be embedded into files such as media files, program instructions an interpretation process 36 for interpreting the language may also be loaded and executing. The interpretation engine preferably implements, or works in conjunction with an implementation, of the process of FIG. 1 in order to enhance performance of scripts or any program that is written in a language that does not support integer datatypes.

Interpretation process 36 may be implemented as part of other processes that provide a programming framework or support for applications. For example, referring to FIG. 4, interpretation process 36 may be implemented as part of “presentation engine” 38. The presentation engine thus includes an implementation of the process described in connection with FIG. 1. The presentation engine process functions to playback multiple-media files 40 on, for example, a video display device (such as a television.) Multi-media files, such as those encoded using the Macromedia® Flash® “.swf” file format, may contain scripts. Indeed, an application such as a game or other graphically-oriented application may be written as an interactive multi-media file, with the presentation engine acting as a middleware or framework for supporting execution on the embedded device. Such a presentation engine is particularly useful when loaded onto a set top box for cable or satellite television. It provides a platform on which applications programmed using a multi media file format containing scripts or other programs without an integer datatype are able to be efficiently executed without need of an FPU.

What is claimed is:

1. A method of increasing the efficiency of execution of program instructions for calculations on central processor unit using a program interpreter executing on the central processor unit, comprising:
reading with the interpreter a program instruction for a calculation; determining with the interpreter if all numbers used in the calculation are integers; and
if all of the numbers used in the calculation are integers, performing the calculation using integer arithmetic operations.

2. The method of claim 1, further comprising:
looking ahead with the interpreter in the program to determine whether a result of the calculation will be used as an integer; and
if the result will be used as an integer, causing execution of the calculation using integer arithmetic.

3. The method of claim 1, further comprising:
applying a test with the interpreter to determine whether the calculation may be executed using integer representation of numbers;
if the test indicates that the calculation can be executed using integer representation of numbers, executing the calculation using integer representation of the numbers.

4. The method of claim 1, wherein the arithmetic calculation is division, and wherein the method further comprises:
determining with the interpreter whether the calculation has a remainder;
if the calculation has a zero remainder, executing the calculation using integer arithmetic.

5. The method of claim 1, further comprising:
determining whether a result of the calculation will be used in a subsequent conversion to an integer number; and
if the result of the calculation will be used in a subsequent conversion to integer, not executing the calculation and defining the result as a division of two numbers.

6. The method of claim 1, wherein the application program is stored as part a multi-media file.

7. The method of claim 6, wherein the multi-media file is encoded using Macromedia® Flash® tags.

8. A medium storing instructions that, when executed by a central processing unit, causes the central processing unit to undertake a process comprising the following:
reading an instruction for an arithmetic calculation in an application program; determining if all numbers used in the calculation are integers; and
if all of the numbers used in the calculation are integers, performing the calculation using integer arithmetic operations.

9. The medium of claim 8, wherein the arithmetic calculation is division, and wherein the instructions cause the central processing unit to undertake a process further comprising:
applying a test with the interpreter to determine whether the calculation may be executed using integer representation of numbers;
if the test indicates that the calculation can be executed using integer representation of numbers, executing the calculation using integer representation of the numbers.

10. The medium of claim 8, wherein the arithmetic calculation is division, and wherein the instructions cause the central processing unit to undertake a process further comprising:
determining whether the calculation has a remainder;
if the calculation has a zero remainder, executing the calculation using integer arithmetic.

11. The medium of claim 10, wherein the instructions cause the central processing unit to undertake a process further comprising:
looking ahead in the program to determine whether a result of the calculation will be used as an integer if the remainder is not zero; and
if the result will be used as an integer, executing the calculation using integer arithmetic.

12. The medium of claim 8, wherein the instructions cause the central processing unit to undertake a process further comprising:
if the remainder is non-zero, determining whether a result of the calculation will be used in a subsequent conversion to an integer number; and
if the result of the calculation will be used in a subsequent conversion to integer, not executing the calculation and defining the result as a division of two numbers.

13. The medium of claim 8, wherein the application program is stored as part a multi-media file.

14. The medium of claim 11, wherein the multi-media file is encoded using a Macromedia® Flash®D format.

15. An embedded device, comprising:
means for reading a program instruction for an arithmetic calculation;
means for determining if all numbers used in the calculation are integers; and
if all of the numbers used in the calculation are integers, means for performing the calculation using integer arithmetic operations.

16. The embedded device of claim 15, further comprising:
means for applying a test with the interpreter to determine whether the calculation may be executed using integer representation of numbers;
means for executing, if the test indicates that the calculation can be executed using integer representation of numbers, the calculation using integer representation of the numbers.

17. The embedded device of claim 15, wherein the arithmetic calculation is division, and wherein the embedded device further comprises:
means for determining whether the calculation has a remainder;
if the calculation has a zero remainder, means for executing the calculation using integer arithmetic.

18. The embedded device of claim 17, further comprising:
means looking ahead in the program to determine whether a result of the calculation will be used as an integer if the remainder is not zero; and
if the result will be used as an integer, means for executing the calculation using integer arithmetic.

19. The embedded device of claim 17, further comprising:
means determining whether, if the division calculation has a non-zero remainder, a result of the calculation will be used in a subsequent conversion to an integer; and
if the result of the calculation will be used in a subsequent conversion to integer, means for defining and storing the result as a division of two integer numbers.

20. The embedded device of claim 15, wherein the embedded device is a set top box.

21. The embedded device of claim 15, wherein the application program is stored as part a multi-media file.

22. The embedded device of claim 15, wherein the multi-media file is encoded using a Macromedia® Flash® format.
